(19) United States
(12) Patent Application Publication
(10) Pub. No.: US 2017/0214903 A1
(43) Pub. Date: Jul. 27, 2017

(54) IMAGING APPARATUS, IMAGING SYSTEM, AND CONTROL METHOD FOR IMAGING APPARATUS

(71) Applicant: SONY CORPORATION, TOKYO (JP)

(72) Inventor: RYUICHI TADANO, KANAGAWA (JP)

(73) Assignee: SONY CORPORATION, TOKYO (JP)

(21) Appl. No.: 15/123,435

(22) PCT Filed: Dec. 8, 2014
(86) PCT No.: PCT/JP2014/082429

§ 371 Date: Sep. 2, 2016

(30) Foreign Application Priority Data
Mar. 13, 2014 (JP) 2014-049898

(51) Int. Cl. H04N 13/02; H04N 5/353; H04N 5/235

(52) U.S. Cl. CPC H04N 13/0296; H04N 13/0239; H04N 5/2353; H04N 5/3532

(57) ABSTRACT

To improve the image quality in an imaging apparatus. A synchronization signal generator generates a synchronization signal indicating a synchronization timing for each of synchronization intervals. A synchronization interval controller changes, when an amount of change of the synchronization interval is input, the synchronization interval according to the amount of change. An imaging element generates image data by performing exposure within an exposure period between an exposure start timing when a start-setting time has elapsed from the synchronization timing and an exposure end timing when an end-setting time has elapsed from the synchronization timing after the exposure start timing. An exposure controller changes, when the amount of change is input, at least one of the start-setting time and the end-setting time on the basis of the amount of change.

### TECHNICAL FIELD

The present technology relates to an imaging apparatus, an imaging system, and a control method for the imaging apparatus. More particularly, the present technology relates to an imaging apparatus that performs imaging in synchronization with a vertical synchronization signal, an imaging system, and a control method for the imaging apparatus.

### BACKGROUND ART

Conventionally, in order to monitor a plurality of monitoring points or acquire depth information or stereoscopic images, an imaging system in which imaging is performed by a plurality of imaging apparatuses at the same time has been used. For example, an imaging system in which a stereoscopic image formed of two images is captured by two cameras and a line-of-sight direction as the depth information is detected from the stereoscopic image has been proposed (e.g., see Patent Document 1). In those cameras, imaging timings are synchronized according to a vertical synchronization signal or the like. In general, the exposure start and end timings are determined on the basis of a vertical synchronization timing, for example, a time when a certain period has elapsed from a vertical synchronization timing indicated by a vertical synchronization signal.

Patent Document 1: Japanese Patent Application Laid-open No. 2007-58507

### SUMMARY

### Problem to be Solved

However, in the above-mentioned conventional technology, when the vertical synchronization timing of one of the two cameras is shifted corresponding to the other, the exposure start and end timings are offset corresponding to a shift amount, which changes the exposure period. Thus, there is a problem in that the image quality of the stereoscopic image is deteriorated as the exposure periods of the two cameras do not match.

The present technology has been conceived in view of the above-mentioned circumstances and it is an object thereof to improve the image quality in the imaging apparatus.

### Means for Solving the Problem

The present technology has been made in order to overcome the above-mentioned problem, and a first aspect thereof is an imaging apparatus including: a synchronization signal generator that generates a synchronization signal indicating a synchronization timing for each of synchronization intervals; a synchronization interval controller that changes, when an amount of change of the synchronization interval is input, the synchronization interval according to the amount of change; an imaging element that generates image data by performing exposure within an exposure period between an exposure start timing when a start-setting time has elapsed from the synchronization timing and an exposure end timing when an end-setting time has elapsed from the synchronization timing after the exposure start timing; and an exposure controller that changes, when the amount of change is input, at least one of the start-setting time and the end-setting time on the basis of the amount of change, and a control therefor. This provides an effect that at least one of the start-setting time and the end-setting time is changed on the basis of the amount of change.

Further, in this first aspect, a photometry unit that measures an amount of light may be further provided, in which the exposure controller may control, when the amount of light is measured, at least one of the start-setting time and the end-setting time on the basis of the amount of light. This provides an effect that at least one of the start-setting time and the end-setting time is controlled on the basis of the amount of light.

Further, a second aspect of the present technology is an imaging system including: a first imaging apparatus including a synchronization signal generator that generates a first synchronization signal indicating a synchronization timing for each of synchronization intervals, a synchronization interval controller that changes, when an amount of change of the synchronization interval is input, the synchronization interval according to the amount of change, an imaging element that generates image data by performing exposure within an exposure period between an exposure start timing when a start-setting time has elapsed from the synchronization timing and an exposure end timing when an end-setting time has elapsed from the synchronization timing after the exposure start timing, and an exposure controller that changes, when the amount of change is input, at least one of the start-setting time and the end-setting time on the basis of the amount of change; a second imaging apparatus including a synchronization signal generator that generates a second synchronization signal indicating a synchronization timing for each of synchronization intervals, a synchronization interval controller that changes, when an amount of change of the synchronization interval is input, the synchronization interval according to the amount of change, an imaging element that generates image data by performing exposure within an exposure period between an exposure start timing when a start-setting time has elapsed from the synchronization timing and an exposure end timing when an end-setting time has elapsed from the synchronization timing after the exposure start timing, and an exposure controller that changes, when the amount of change is input, at least one of the start-setting time and the end-setting time on the basis of the amount of change; and a synchronization managing apparatus that determines the amount of change according to a phase difference between the first and second synchronization signals and inputs the amount of change into at least one of the first and second imaging apparatuses. This provides an effect that at least one of the start-setting time and the end-setting time is changed on the basis of the amount of change.

Further, a third aspect of the present technology is an imaging system including: a synchronization signal generator that generates a synchronization signal indicating a synchronization timing for each of synchronization intervals; a synchronization interval controller that changes, when an amount of change of the synchronization interval is input, the synchronization interval according to the amount of change; an imaging element that generates image data by performing exposure within an exposure period between an exposure start timing when a start-setting time has elapsed from the synchronization timing and an exposure end timing when an end-setting time has elapsed from the synchronization timing after the exposure start timing; an exposure controller that changes, when the amount of change is input, at least one of the start-setting time and the end-setting time on the basis of the amount of change; and a synchronization managing apparatus that determines the shift amount according to a phase difference between the synchronization timing and a predetermined reference timing and inputs the shift amount into at least one of the first and second imaging apparatuses. This provides an effect that at least one of the start-setting time and the end-setting time is changed on the basis of the amount of change.

Further, a fourth aspect of the present technology is an imaging apparatus including: a first imaging unit including a synchronization signal generator that generates a first synchronization signal indicating a synchronization timing for each of synchronization intervals, a synchronization interval controller that changes, when an amount of change of the synchronization interval is input, the synchronization interval according to the amount of change, an imaging element that generates image data by performing exposure within an exposure period between an exposure start timing when a start-setting time has elapsed from the synchronization timing and an exposure end timing when an end-setting time has elapsed from the synchronization timing after the exposure start timing, and an exposure controller that changes, when the amount of change is input, at least one of the start-setting time and the end-setting time on the basis of the amount of change; a second imaging unit including a synchronization signal generator that generates a second synchronization signal indicating a synchronization timing for each of synchronization intervals, a synchronization interval controller that changes, when an amount of change of the synchronization interval is input, the synchronization interval according to the amount of change, an imaging element that generates image data by performing exposure within an exposure period between an exposure start timing when a start-setting time has elapsed from the synchronization timing and an exposure end timing when an end-setting time has elapsed from the synchronization timing after the exposure start timing, and an exposure controller that changes, when the amount of change is input, at least one of the start-setting time and the end-setting time on the basis of the amount of change; and a synchronization manager that determines the amount of change according to a phase difference between the first and second synchronization signals and inputs the amount of change into at least one of the first and second imaging apparatuses. This provides an effect that at least one of the start-setting time and the end-setting time is changed on the basis of the amount of change.

### Effects

In accordance with the present technology, it is possible to exert an excellent effect of improving the image quality in the imaging apparatus. It should be noted that the effect described here is not necessarily limitative and may be any effect described in the present disclosure.

### BRIEF DESCRIPTION OF DRAWINGS

FIG. 1 A block diagram showing a configuration example of an imaging system in a first embodiment.

FIG. 2 A block diagram showing a configuration example of a left-hand imaging apparatus in the first embodiment.

FIG. 3 A block diagram showing a configuration example of an imaging element in the first embodiment.

FIG. 4 A circuit diagram showing a configuration example of a pixel circuit in the first embodiment.

FIG. 5 An example of a timing chart showing an operation of the imaging apparatus in the first embodiment.

FIG. 6 An example of a timing chart showing an operation of the imaging apparatus in a comparison example of the first embodiment.

FIG. 7 An example of a timing chart showing an operation of the imaging apparatus in changing an end-setting time in the first embodiment.

FIG. 8 An example of a timing chart showing an operation of the imaging element in the first embodiment.

FIG. 9 An example of a flowchart showing an operation of the imaging apparatus in the first embodiment.

FIG. 10 A block diagram showing a configuration example of an imaging system in a second embodiment.

FIG. 11 A block diagram showing a configuration example of a binocular imaging apparatus in a third embodiment.

### DESCRIPTION OF PREFERRED EMBODIMENTS

Hereinafter, embodiments for carrying out the present technology (hereinafter, referred to as embodiments) will be described. The descriptions will be made in the following order.

1. First Embodiment (example in which start-setting time or end-setting time is controlled in a plurality of imaging apparatuses)

2. Second Embodiment (example in which start-setting time or end-setting time is controlled in single imaging apparatus)

3. Third Embodiment (example in which start-setting time or end-setting time is controlled in binocular imaging apparatus)

### 1. First Embodiment

[Configuration Example of Imaging System]

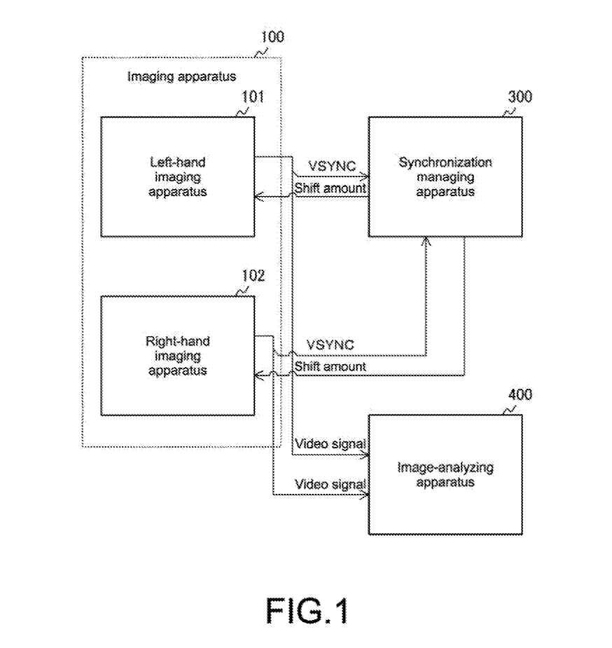

FIG. 1 is a block diagram showing a configuration example of an imaging system in an embodiment. This imaging system is a system for capturing a stereoscopic image formed of two images and includes a plurality of imaging apparatuses 100 such as a left-hand imaging apparatus 101 and a right-hand imaging apparatus 102, a synchronization managing apparatus 300, and an image-analyzing apparatus 400. Here, an imaging target is an object around an automobile, for example. The left-hand imaging apparatus 101 and the right-hand imaging apparatus 102 are, in the automobile, disposed on the left- and right-hand sides facing the imaging target, respectively. Note that the left-hand imaging apparatus 101 is an example of a first imaging apparatus described in the scope of claims and the right-hand imaging apparatus 102 is an example of a second imaging apparatus described in the scope of claims.

Although the imaging apparatuses 100 are disposed in the automobile, they may be disposed at positions other than the inside of the automobile. For example, the imaging apparatuses 100 may be disposed at indoor or outdoor monitoring points and may be used as monitoring cameras.

Each of the imaging apparatuses 100 generates a vertical synchronization signal VSYNC and perform imaging in synchronization with the vertical synchronization signal VSYNC. This vertical synchronization signal VSYNC is a signal indicating vertical synchronization timings at predetermined intervals. For example, generation of the vertical synchronization signal VSYNC is started when an imaging start operation is made by the user and ended when an imaging end operation is made. Note that generation of the vertical synchronization signal VSYNC may be configured to be started or ended at a predetermined set point of time.

When receiving a shift amount from the synchronization managing apparatus 300, the imaging apparatus 100 shifts the vertical synchronization timing by the shift amount. The unit of this shift amount is, for example, micro second (μs) or cycles of a clock signal having a predetermined cycle. Further, the imaging apparatus 100 generates a video signal by imaging and transmits it to the image-analyzing apparatus 400. This video signal includes moving-image data formed of a plurality of continuous image data items and the vertical synchronization signal VSYNC. The vertical synchronization signal VSYNC of the video signal is also transmitted to the synchronization managing apparatus 300 as well as the image-analyzing apparatus 400.

The synchronization managing apparatus 300 causes the vertical synchronization timings of the plurality of imaging apparatuses 100 to match. This synchronization managing apparatus 300 determines a phase difference of the vertical synchronization signals VSYNC of the imaging apparatuses 100 and determines a shift amount according to that phase difference. For example, if a phase difference between two vertical synchronization timings is 10 micro seconds, the synchronization managing apparatus 300 only needs to shift only one of those vertical synchronization timings by 10 micro seconds or shift the both by 5 micro seconds. The synchronization managing apparatus 300 transmits the shift amount to the imaging apparatus 100 that should shift the vertical synchronization signal VSYNC.

The image-analyzing apparatus 400 analyses the video signal from the imaging apparatus 100. For example, the image-analyzing apparatus 400 analyzes the video signal and determines depth information or a line-of-sight direction. Note that the image-analyzing apparatus 400 may generate, from those video signals, an overhead image, a panoramic image, a three-dimensional image, and the like.

In addition, although the imaging system is configured to include the two imaging apparatuses (101 and 102), it may be configured to include three or more imaging apparatuses such that they perform imaging in synchronization with one another.

[Configuration Example of Imaging Apparatus]

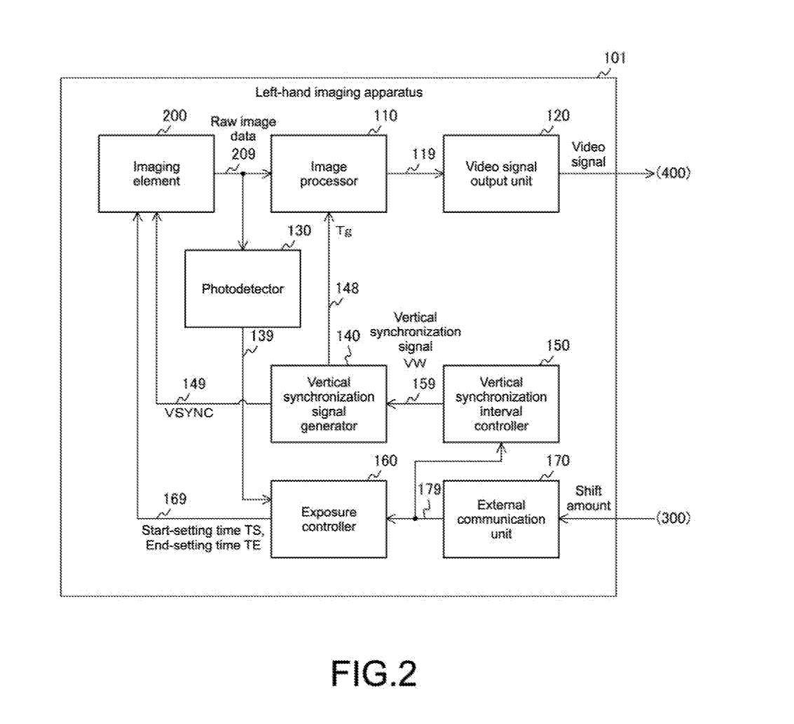

FIG. 2 is a block diagram showing a configuration example of the left-hand imaging apparatus 101 in the first embodiment. This left-hand imaging apparatus 101 includes an imaging element 200, an image processor 110, a video signal output unit 120, a photodetector 130, a vertical synchronization signal generator 140, a vertical synchronization interval controller 150, an exposure controller 160, and an external communication unit 170. Note that a configuration of the right-hand imaging apparatus 102 is the same as the left-hand imaging apparatus 101.

The external communication unit 170 receives a shift amount from the synchronization managing apparatus 300. This shift amount is transmitted and received through, for example, an I2C (Inter-Integrated Circuit) interface or an SPI (Serial Peripheral Interface) interface. The external communication unit 170 supplies the received shift amount to the exposure controller 160 and the vertical synchronization interval controller 150 via a signal line 179.

The vertical synchronization interval controller 150 controls a vertical synchronization interval VW that is an interval of the vertical synchronization timing. The vertical synchronization interval controller 150 sets, if the shift amount is “0,” a predetermined initial value (e.g., 1/60 seconds) as the vertical synchronization interval VW. On the other hand, if the shift amount is not “0,” the vertical synchronization interval controller 150 sets a value obtained by changing the initial value by the shift amount, for the vertical synchronization interval VW. With this, the vertical synchronization timing is shifted by the shift amount. Setting of the vertical synchronization interval VW is, for example, performed at vertical synchronization intervals. The vertical synchronization interval controller 150 supplies the set vertical synchronization interval VW to the vertical synchronization signal generator 140 via a signal line 159. Note that the vertical synchronization interval controller 150 is an example of a synchronization interval controller described in the scope of claims.

The vertical synchronization signal generator 140 generates the vertical synchronization signal VSYNC on the basis of the vertical synchronization interval VW from the vertical synchronization interval controller 150. This vertical synchronization signal generator 140 supplies the generated vertical synchronization signal VSYNC to the imaging element 200 via a signal line 149. Further, the vertical synchronization signal generator 140 generates, on the basis of the vertical synchronization interval VW, an image processing timing signal Tg indicating a timing for starting image processing and supplies it to the image processor 110 via a signal line 148. Note that the vertical synchronization signal generator 140 is an example of a synchronization signal generator described in the scope of claims.

The exposure controller 160 controls an exposure period. This exposure controller 160 receives a measurement value of the amount of light from the photodetector 130 and determines an exposure period on the basis of this measurement value. In general, an exposure value indicating a degree of exposure is expressed by a predetermined relational expression using an exposure period and an f-number. The exposure controller 160 calculates, for example, an appropriate exposure value from the measurement value and calculates an appropriate exposure period on the basis of the exposure value and the f-number according to the above-mentioned relational expression. Calculation of the exposure period is performed, for example, in synchronization with the vertical synchronization signal. Further, the measurement value cannot be obtained immediately after imaging start (e.g., 0th frame), and hence the initial value is set as the exposure period. Such a function of the imaging apparatus determining the appropriate exposure period and f-number on the basis of the measurement value of the amount of light is called automatic exposure function.

Although the exposure controller 160 determines the exposure period by the automatic exposure function, it is not limited to this configuration. For example, the exposure controller 160 may set the exposure period according to a user's operation.

Here, a relationship shown in the Expressions below is established between the exposure period and the vertical synchronization interval VW.

(exposure period)=(vertical synchronization interval VW)−(charge sweeping period) Expression 1

(charge sweeping period)=(start-setting time TS)−(end-setting time TE) Expression 2

Where the start-setting time TS indicates a time from the vertical synchronization timing to an exposure start timing and the end-setting time TE indicates a time from the vertical synchronization timing to an exposure end timing. The unit of the exposure period, the start-setting time TS, and the end-setting time TE is micro second (μs), for example.

Using Expression 1 and Expression 2, the exposure controller 160 determines, based on appropriate exposure period and vertical synchronization interval VW, the start-setting time TS and the end-setting time TE. For example, setting the end-setting time TE to a predetermined fixed value, the exposure controller 160 determines the start-setting time TS satisfying Expression 1 and Expression 2.

Further, when changing the vertical synchronization interval VW according to the shift amount, the exposure controller 160 changes at least one of the start-setting time TS and the end-setting time TE on the basis of a shift amount thereof. In other words, the exposure controller 160 changes the charge sweeping period on the basis of the shift amount. For example, setting the end-setting time TE to a predetermined value and setting the exposure period to the same value as before shifting, the exposure controller 160 determines the start-setting time TS according to Expression 1 and Expression 2. Then, the exposure controller 160 supplies the determined start-setting time TS and the end-setting time TE to the imaging element 200.

As described above, the shift amount is transmitted by a normal communication interface such as an I2C interface and the exposure start and end timings are controlled on the basis of the shift amount. Therefore, it is unnecessary to transmit and receive information on those timings between the synchronization managing apparatus 300 and the imaging apparatus. Therefore, it is unnecessary to separately provide hardware such as a signal line for controlling exposure.

The imaging element 200 performs imaging on the basis of the vertical synchronization signal VSYNC, the start-setting time TS, and the end-setting time TE. This imaging element 200 starts exposure at the exposure start timing when the start-setting time TS has elapsed from the vertical synchronization timing. Then, the imaging element 200 terminates the exposure at the exposure end timing when the end-setting time TE has elapsed from the vertical synchronization timing after the exposure start timing and generates raw image data. Every time the raw image data is generated, the imaging element 200 supplies that data to the image processor 110 and the photodetector 130 via a signal line 209.

The photodetector 130 measures the amount of light from the raw image data. The photodetector 130 supplies the measurement value of the amount of light to the exposure controller 160 via a signal line 139.

The image processor 110 performs predetermined image processing on the raw image data in synchronization with the image processing timing signal Tg. For example, demosaicing, white balance processing, gamma correction, and color format conversion are performed depending on needs. A YC conversion is, for example, performed as the color format conversion. In the YC conversion, a format in which the colors are expressed with RGB (Red Green Blue) is converted into a format in which the colors are expressed with a luminance and a color difference. The image processor 110 supplies the image data after the image processing to the video signal output unit 120 via a signal line 119.

The video signal output unit 120 generates a video signal from the image data and transmit it to the image-analyzing apparatus 400. The video signal is transmitted via a composite cable, for example.

[Configuration Example of Imaging Element]

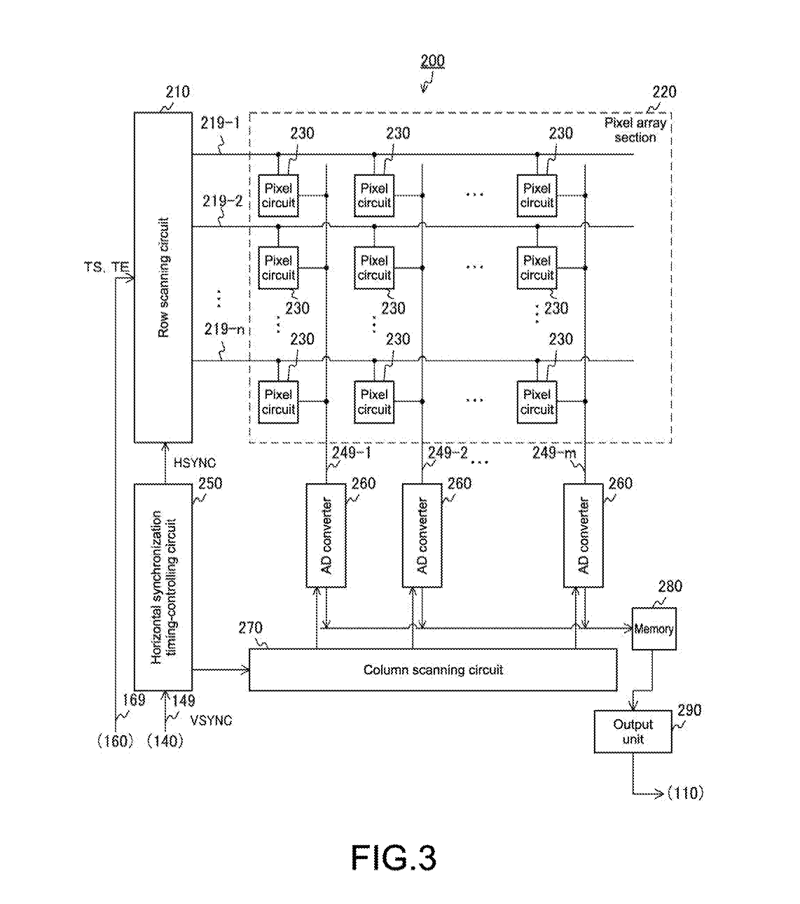

FIG. 3 is a block diagram showing a configuration example of the imaging element 200 in the first embodiment. This imaging element 200 includes a row scanning circuit 210, a pixel array section 220, a horizontal synchronization timing-controlling circuit 250, a plurality of AD (Analog to Digital) converters 260, a column scanning circuit 270, a memory 280, and an output unit 290.

In the pixel array section 220, a plurality of pixel circuits 230 are arranged in a two-dimensional grid form. In the pixel array section 220, the pixel circuits 230 in an n row by m column matrix, for example, are provided. Here, n and m are integers. Each of the pixel circuits 230 includes pixels in 2 row by 2 column matrix. That is, in the pixel array section 220, pixels in a 2n row by 2m column matrix are arranged. Hereinafter, the row and column of the pixel circuits 230 will be referred to as a “circuit row” and a “circuit column,” respectively and the row and column of the pixels will be referred to as a “pixel row” and a “pixel column,” respectively.

The row scanning circuit 210 sequentially selects the circuit rows. This row scanning circuit 210 receives a horizontal synchronization signal HSYNC from the horizontal synchronization timing-controlling circuit 250. Then, the row scanning circuit 210 sequentially supplies, in synchronization with the horizontal synchronization signal HSYNC, a row-selecting signal for selecting (in other words, scanning) the circuit row, to each of the circuit rows. The row-selecting signals are supplied via horizontal signal lines 219-1 to 219-n.

Further, the row scanning circuit 210 receives the start-setting time TS and the end-setting time TE from the exposure controller 160 and starts exposure of a first circuit row at the exposure start timing when the start-setting time TS has elapsed from the vertical synchronization timing. With this, the exposure of the first and second pixel rows is started. In the nth circuit row following the second row, the exposure is started at the exposure start timing when (n−1)*Td micro seconds (μs) has elapsed from the exposure start timing in the first row.

Then, the row scanning circuit 210 terminates the exposure of the first circuit row at the exposure end timing when the end-setting time TE has elapsed from a vertical synchronization timing subsequent to the exposure start timing for the first row. With this, the exposure of the first and second pixel rows is terminated. With respect to the nth circuit row following the second row, the exposure is terminated at an exposure end timing when (n−1)*Td micro seconds (μs) has elapsed from the exposure end timing for the first row. A system for sequentially performing exposure of the circuit rows in this manner is called rolling shutter system.

Note that the imaging element 200 may perform exposure using a global shutter system in which exposure is started and terminated in all pixels at the same timing.

The pixel circuits 230 function to convert light into charges and accumulate them over the exposure period. Then, each of the pixel circuits 230 supplies an electrical signal having a voltage depending on the amount of accumulated charges to the AD converter 260 via a signal line in a corresponding column of signal lines 249-1 to 249-m.

The AD converter 260 converts the analog electrical signal into a digital signal. The AD converter 260 is provided for each circuit column. Each AD converter 260 receives a column-selecting signal from the column scanning circuit 270 and then causes the memory 280 to store the converted digital signal.

The memory 280 stores digital signals for at least one circuit row (i.e., two pixel rows). The output unit 290 sequentially reads out the two pixel rows from the memory 280 and supply them to the image processor 110 via the signal line 209.

The horizontal synchronization timing-controlling circuit 250 controls the row scanning circuit 210 and the column scanning circuit 270. The horizontal synchronization timing-controlling circuit 250 generates the horizontal synchronization signal HSYNC from the vertical synchronization signal VSYNC. This horizontal synchronization signal HSYNC is a signal indicating a timing for scanning the circuit column. The horizontal synchronization timing-controlling circuit 250 supplies the generated horizontal synchronization signal HSYNC to the row scanning circuit 210. Further, the horizontal synchronization timing-controlling circuit 250 generates a column-scanning timing signal indicating a timing for scanning the circuit column and supplies it to the column scanning circuit 270.

The column scanning circuit 270 sequentially supplies column-selecting signals for selecting the circuit columns to the AD converters 260 according to the column-scanning timing signals.

[Configuration Example of Pixel Circuit]

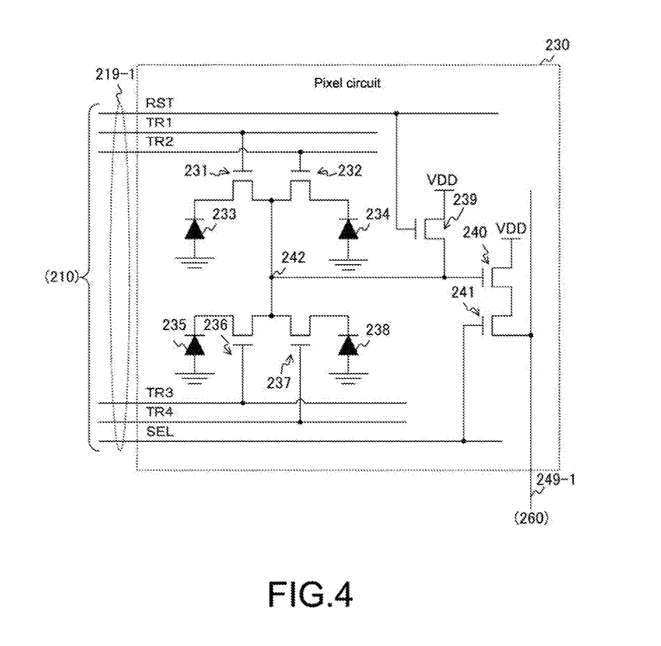

FIG. 4 is a circuit diagram showing a configuration example of the pixel circuit 230 in the first embodiment. This pixel circuit 230 includes transfer transistors 231, 232, 236, and 237, photoelectric conversion elements 233, 234, 235, and 238, a reset transistor 239, an amplification transistor 240, a select transistor 241, and a floating diffusion layer 242.

The photoelectric conversion elements 233, 234, 235, and 238 function to convert received light into charges and accumulates them. The photoelectric conversion element 233 is connected to the transfer transistor 231. The photoelectric conversion element 234 is connected to the transfer transistor 232. Further, the photoelectric conversion element 235 is connected to the transfer transistor 236. The photoelectric conversion element 238 is connected to the transfer transistor 237.

The transfer transistors 231, 232, 236, and 237 function to transfer the accumulated charges to the floating diffusion layer 242. As the transfer transistors 231, 232, 236, and 237, for example, n-type MOS (Metal-Oxide-Semiconductor) transistors are used. Those transistors have gates which are connected to the row scanning circuit 210 and into which transfer signals TR1, TR2, TR3, and TR4 are input. Further, the transfer transistors 231, 232, 236, and 237 have drains commonly connected to the floating diffusion layer 242 and sources individually connected to the photoelectric conversion elements 233, 234, 235, and 238.

The floating diffusion layer 242 accumulates the transferred charges and generates a voltage depending on the amount of charge. This floating diffusion layer 242 is connected to the transfer transistors 231, 232, 236, and 237, the reset transistor 239, and the amplification transistor 240.

The reset transistor 239 sets the amount of charge accumulated in the floating diffusion layer 242 and the photoelectric conversion elements 233, 234, 235, and 238 to the initial value. For example, an n-type MOS transistor is used as the reset transistor 239. This reset transistor 239 have a gate which is connected to the row scanning circuit 210 and into which a reset signal RST is input, a source which is connected to the power supply, and a drain which is connected to the floating diffusion layer 242.

The amplification transistor 240 amplifies a voltage generated by the floating diffusion layer 242. For example, an n-type MOS transistor is used as the amplification transistor 240. This amplification transistor 240 has a gate connected to the floating diffusion layer 242, a source connected to the power supply, and a drain connected to the select transistor 241.

The select transistor 241 supplies, when the circuit row is selected, an electrical signal having a voltage amplified by the amplification transistor 240 to the corresponding AD converter 260 via a vertical signal line. For example, an n-type MOS transistor is used as the select transistor 241. This select transistor 241 has a gate which is connected to the row scanning circuit 210 and into which a select signal SEL is input, a source which is connected to the amplification transistor 240, and a drain which is connected to the corresponding AD converter 260 via the vertical signal line.

Although the four photoelectric conversion elements (233, 234, 235, and 238) are, as illustrated in FIG. 4, configured to commonly include the floating diffusion layer 242, the reset transistor 239, the amplification transistor 240, and the select transistor 241, it is not limited to this configuration. For example, for each photoelectric conversion element, a configuration in which the floating diffusion layer 242, the reset transistor 239, the amplification transistor 240, and the select transistor 241 are provided may be employed. In this case, the exposure is performed for each pixel row.

[Operation Example of Imaging Apparatus]

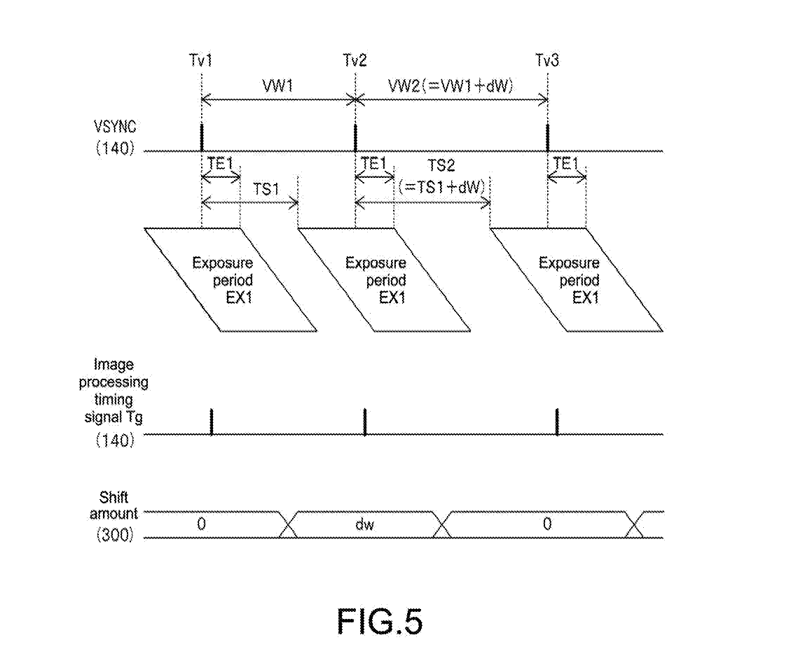

FIG. 5 is an example of a timing chart showing an operation of the imaging apparatus 100 in the first embodiment. The vertical synchronization signal generator 140 generates a vertical synchronization signal VSYNC having a vertical synchronization interval VW1.

The imaging element 200 starts exposure of the first circuit row at an exposure start timing when a start-setting time TS1 has elapsed from a vertical synchronization timing Tv1 and sequentially starts exposure of the second row and following rows. Then, the exposure of the first circuit row is terminated at an exposure start timing when an end-setting time TE1 has elapsed from a vertical synchronization timing Tv2 subsequent to the vertical synchronization timing Tv1 and the exposure of the second row and following rows is sequentially terminated.

Further, the vertical synchronization signal generator 140 generates an image processing timing signal Tg and the image processor 110 performs image processing on the raw image data according to that signal.

The synchronization managing apparatus 300 determines a shift amount on the basis of a phase difference between the vertical synchronization signals VSYNC of the two imaging apparatuses (101 and 102).

Here, it is assumed that a shift amount dW is transmitted to the left-hand imaging apparatus 101 between the vertical synchronization timings Tv1 and Tv2. In this case, the vertical synchronization signal generator 140 in the left-hand imaging apparatus 101 controls the vertical synchronization interval to be VW2 obtained by adding the shift amount dW to VW1. With this, a vertical synchronization timing subsequent to the vertical synchronization timing Tv2 is shifted by the shift amount dW.

On the other hand, the exposure controller 160 controls the start-setting time to be TS2 obtained by adding the shift amount dW to TS1. Therefore, the imaging element 200 starts the exposure of the first circuit row at an exposure start timing when the start-setting time TS2 has elapsed from the vertical synchronization timing Tv2, sequentially starts the exposure of the second row and following rows, and sequentially starts the exposure of the second row and following rows. Then, the exposure of the first circuit row is terminated at an exposure start timing when the end-setting time TE1 has elapsed from a shifted vertical synchronization timing Tv3 and the exposure of the second row and following rows is sequentially terminated.

As illustrated in FIG. 5, the start-setting time is changed and the exposure start timing is also shifted by a shift amount of the vertical synchronization timing, and hence the exposure period after shifting takes an appropriate value identical to that before shifting. Therefore, it is possible to improve the image quality of the image.

In contrast, if the start-setting time has not been changed, the exposure period does not take the appropriate value before shifting and the image quality is deteriorated.

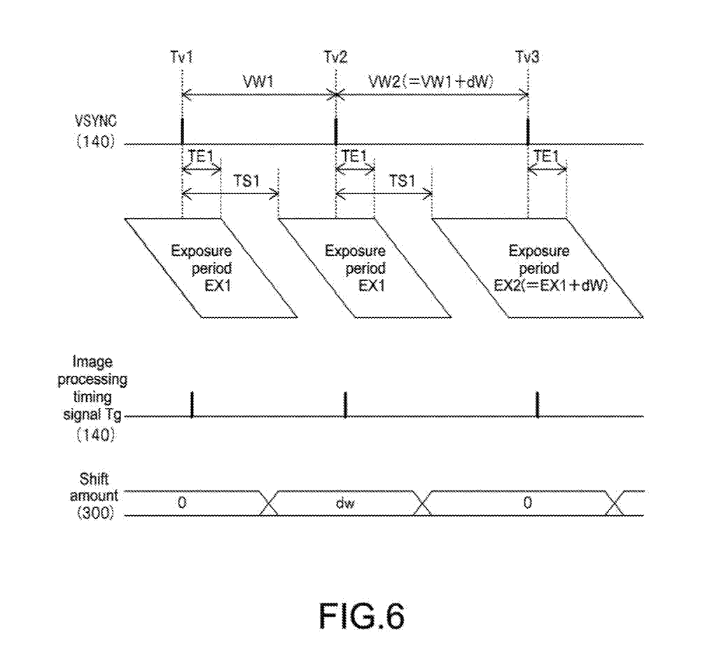

FIG. 6 is an example of a timing chart showing an operation of an imaging apparatus in a comparison example of the first embodiment. In the imaging apparatus of the comparison example, it is assumed that even when the shift amount is received, the start-setting time is not changed. In this imaging apparatus, when the vertical synchronization timing is shifted by the shift amount dW, the exposure period takes a value different from that before shifting by the shift amount dW according to Expression 1 and Expression 2. As a result, the exposure period does not take an appropriate value and the image quality of a captured image is deteriorated.

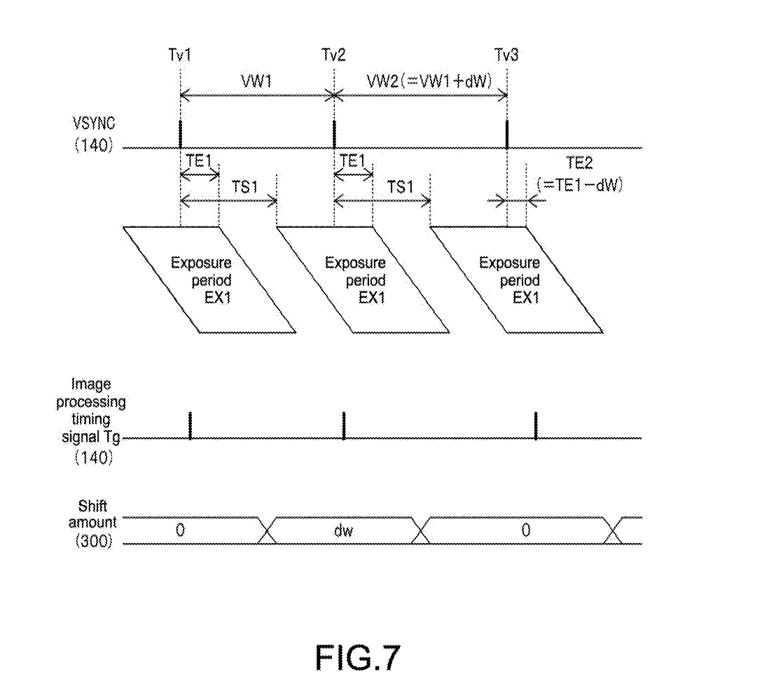

Although the imaging apparatus 100 changes the start-setting time TS according to the shift amount dW such that the exposure period takes a fixed value, the end-setting time TE may be, as illustrated in FIG. 7, changed according to the shift amount such that the exposure period takes a fixed value. For example, if the shift amount is +10 micro seconds, the imaging apparatus 100 changes the end-setting time by −10 micro seconds. Further, the imaging apparatus 100 may change both of the start-setting time TS and the end-setting time TE according to the shift amount. For example, if the shift amount is +10 micro seconds, the imaging apparatus 100 changes the start-setting time TS by +5 micro seconds and changes the end-setting time by −5 micro seconds.

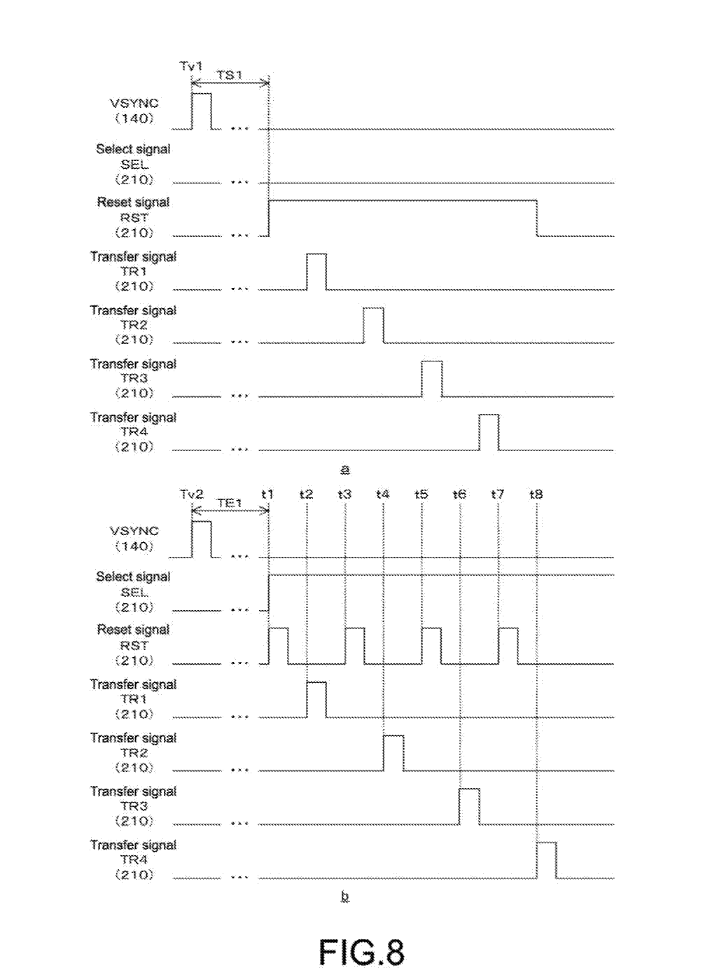

FIG. 8 is an example of a timing chart showing an operation of the imaging element 200 in the first embodiment. “A” of the figure is an example of a timing chart showing an operation of the imaging element 200 at the start of the exposure. When the start-setting time TS1 has elapsed from the vertical synchronization timing Tv1, the row scanning circuit 210 sets the reset signal RST to be at a high level over a predetermined reset period. Within that reset period, the row scanning circuit 210 sequentially controls the transfer signals TR1, TR2, TR3, and TR4 to be at a high level over the certain period. With this, the amount of charge in the pixel circuits 230 is initialized and the exposure of the circuit row corresponding to the pixel circuits 230 is started.

“B” of FIG. 8 is an example of a timing chart showing an operation of the imaging element 200 at the end of the exposure. At a timing t1 when the end-setting time TE1 has elapsed from the vertical synchronization timing Tv2 subsequent to the vertical synchronization timing Tv1, the row scanning circuit 210 sets the select signal SEL to be at a high level and sets the reset signal RST to be at a high level in the predetermined period. At a timing t2 after that, the row scanning circuit 210 sets a transfer signal TR1 to be at a high level in a predetermined period. With this, charges accumulated in the photoelectric conversion element 233 are transferred to the floating diffusion layer 242 and read out. At a timing t3 after that, the row scanning circuit 210 sets the reset signal RST to be at a high level in a predetermined period and sets, at a timing t4 after that, the transfer signal TR1 to be at a high level in the predetermined period. With this, charges accumulated in the photoelectric conversion element 234 are transferred to the floating diffusion layer 242 and read out. Similarly, the row scanning circuit 210 controls the reset signal RST and the transfer signals TR3 and TR4 to perform read-out of the charges accumulated in the photoelectric conversion elements 235 and 238. By such controls, the exposure is terminated and an electrical signal having a voltage depending on the amount of accumulated charges is read out.

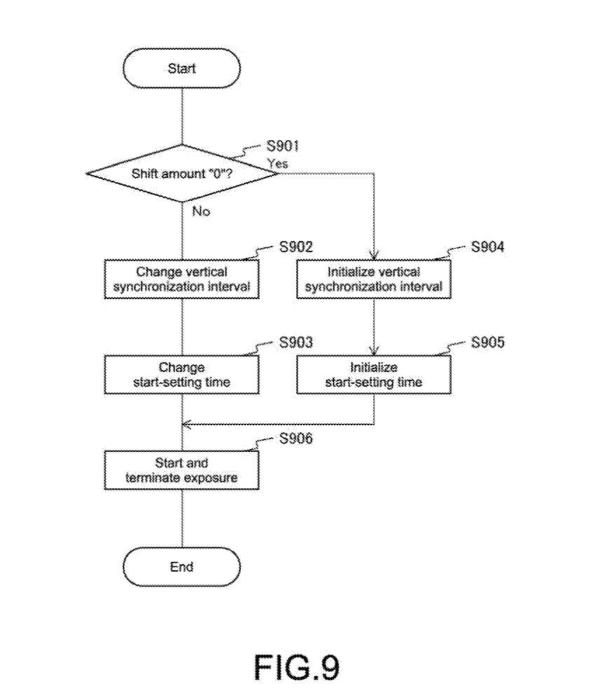

FIG. 9 is an example of a flowchart showing an operation of the imaging apparatus 100 in the first embodiment. This operation is repeatedly executed at vertical synchronization intervals, for example.

The imaging apparatus 100 determines whether or not the shift amount is “0” (Step S901). If the shift amount is not “0” (Step S901: No), the imaging apparatus 100 changes the vertical synchronization interval according to the shift amount (Step S902). Further, the imaging apparatus 100 changes the start-setting time according to the shift amount (Step S903).

On the other hand, if the shift amount is “0” (Step S901: Yes), the imaging apparatus 100 sets the vertical synchronization interval to the initial value (Step S904) and also sets the start-setting time to the initial value (Step S905). After Step S903 or Step S905, the imaging apparatus 100 sequentially starts and terminates the exposure of the circuit rows (Step S906).

In this manner, in accordance with the first embodiment of the present technology, the plurality of imaging apparatuses change the vertical synchronization interval according to the shift amount and at least one of the start-setting time and the end-setting time, and hence it is possible to maintain the exposure period a constant value. With this, it is possible to improve the image quality of the stereoscopic image.

### 2. Second Embodiment

In the first embodiment, the plurality of imaging apparatuses (e.g., 101 and 102) perform imaging in synchronization with each other. However, a single imaging apparatus may perform imaging in synchronization with the vertical synchronization signal VSYNC. An imaging system according to a second embodiment is different from that of the first embodiment in that the single imaging apparatus performs imaging in synchronization with the vertical synchronization signal VSYNC.

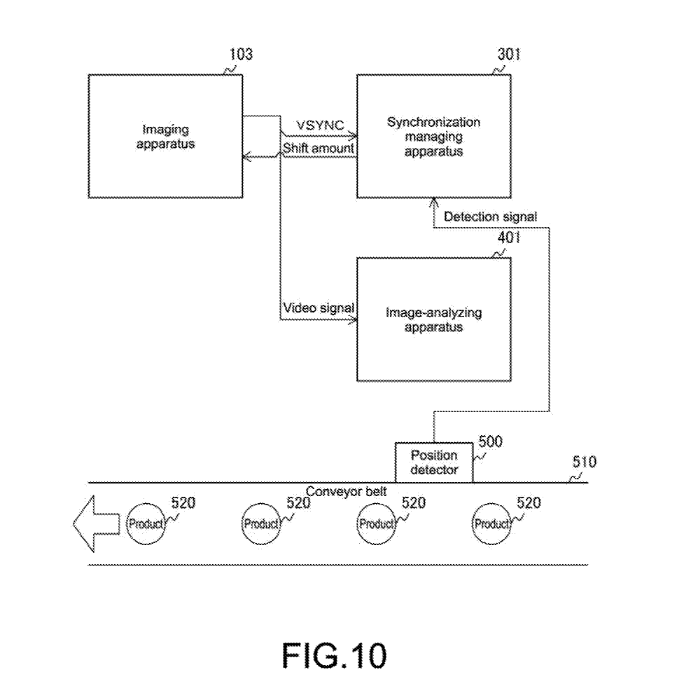

FIG. 10 is a block diagram showing a configuration example of the imaging system in the second embodiment. This imaging system includes an imaging apparatus 103, a synchronization managing apparatus 301, an image-analyzing apparatus 401, and a position detector 500.

The imaging apparatus 103 is placed at a predetermined monitoring point near a conveyor belt 510. The conveyor belt 510 moves a plurality of products 520 in a predetermined direction at a constant speed.

The position detector 500 detects the positions of the products 520 on the conveyor belt 510 with an infrared ray sensor or the like. The position detector 500 supplies a detection result to the synchronization managing apparatus 301.

The synchronization managing apparatus 301 determines a shift amount based on the detection result of the position. For example, with a timing when the product 520 passes through an imaging range of the imaging apparatus 103 being a reference timing, a phase difference between the reference timing and the vertical synchronization timing is determined as the shift amount. A configuration of the imaging apparatus 103 is the same as the left-hand imaging apparatus 101 according to the first embodiment. The image-analyzing apparatus 401 analyzes a video signal and performs detection of a defect of the product 520 or the like.

In this manner, in accordance with the second embodiment of the present technology, the single imaging apparatus changes the vertical synchronization interval according to the shift amount and changes at least one of the start-setting time and the end-setting time, and hence it is possible to maintain the exposure period a constant value. With this, it is possible to improve the image quality of the image.

### 3. Third Embodiment

In the first embodiment, the plurality of imaging apparatuses (101 and 102) perform imaging in synchronization with each other. However, a single binocular imaging apparatus can also be configured to perform imaging. An imaging system according to a third embodiment is different from that of the first embodiment in that the single binocular imaging apparatus performs imaging.

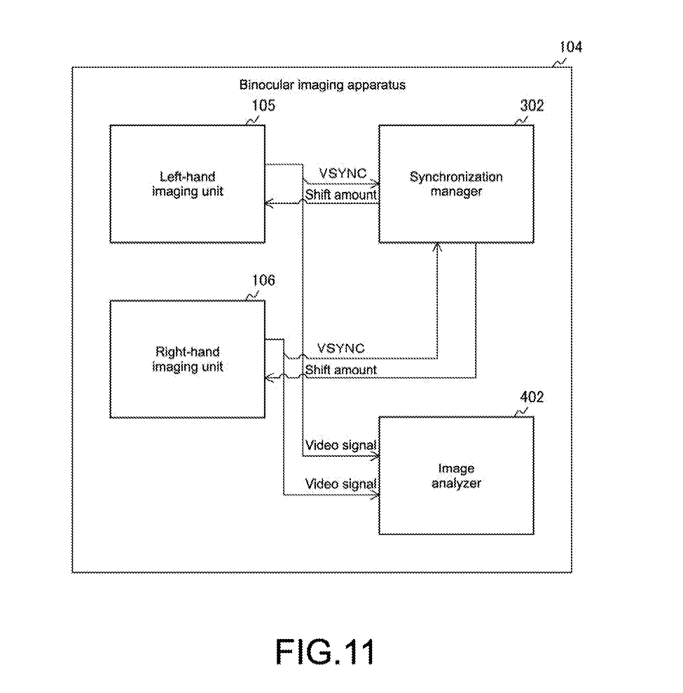

FIG. 11 is a block diagram showing a configuration example of a binocular imaging apparatus 104 in the third embodiment. This binocular imaging apparatus 104 includes a left-hand imaging unit 105, a right-hand imaging unit 106, a synchronization manager 302, and an image analyzer 402.

A configuration of the left-hand imaging unit 105 is the same as the left-hand imaging apparatus 101 in the first embodiment. A configuration of the right-hand imaging unit 106 is the same as the left-hand imaging unit 105. A configuration of the synchronization manager 302 is the same as the synchronization managing apparatus 300 in the first embodiment. A configuration of the image analyzer 402 is the same as the image-analyzing apparatus 400 in the first embodiment. Note that the left-hand imaging unit 105 is an example of a first imaging unit described in the scope of claims and the right-hand imaging unit 106 is an example of a second imaging unit described in the scope of claims.

In this manner, in accordance with the third embodiment of the present technology, the two imaging units change the vertical synchronization intervals according to the shift amount and change at least one of the start-setting time and the end-setting time, and hence it is possible to maintain the exposure period a constant value. With this, it is possible to improve the image quality of the stereoscopic image.

Note that the above-mentioned embodiments provide examples for embodying the present technology and the matters in the embodiments and the specifying matters in the scope of claims are associated. Similarly, the specifying matters in the scope of claims and the matters in the embodiments of the present technology, which are denoted by the identical names, have correspondence. It should be noted that the present technology is not limited to the embodiments and can be embodied by making various modifications to the embodiments without departing from its essence.

Further, the processing procedures described in the above embodiments may be construed as methods including those series of procedures or a program for causing a computer to execute those series of procedures or may be construed as a recording medium storing that program. As this recording medium, a CD (Compact Disc), an MD (Mini Disc), a DVD (Digital Versatile Disc), a memory card, and a Blu-ray (registered trademark) disc can be used, for example.

It should be noted that the effect described here is not necessarily limitative and may be any effect described in the present disclosure.

It should be noted that the present technology may also take the following configurations.

(1) An imaging apparatus, including:

a synchronization signal generator that generates a synchronization signal indicating a synchronization timing for each of synchronization intervals;

a synchronization interval controller that changes, when an amount of change of the synchronization interval is input, the synchronization interval according to the amount of change;

an imaging element that generates image data by performing exposure within an exposure period between an exposure start timing when a start-setting time has elapsed from the synchronization timing and an exposure end timing when an end-setting time has elapsed from the synchronization timing after the exposure start timing; and

an exposure controller that changes, when the amount of change is input, at least one of the start-setting time and the end-setting time on the basis of the amount of change.

(2) The imaging apparatus according to (1), further including a photometry unit that measures an amount of light, in which

the exposure controller controls, when the amount of light is measured, at least one of the start-setting time and the end-setting time on the basis of the amount of light.

(3) An imaging system, including:

a first imaging apparatus including
a synchronization signal generator that generates a first synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change;

a second imaging apparatus including
a synchronization signal generator that generates a second synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change; and

a synchronization managing apparatus that determines the amount of change according to a phase difference between the first and second synchronization signals and inputs the amount of change into at least one of the first and second imaging apparatuses.

(4) An imaging system, including:

a synchronization signal generator that generates a synchronization signal indicating a synchronization timing for each of synchronization intervals;

a synchronization interval controller that changes, when an amount of change of the synchronization interval is input, the synchronization interval according to the amount of change;

an imaging element that generates image data by performing exposure within an exposure period between an exposure start timing when a start-setting time has elapsed from the synchronization timing and an exposure end timing when an end-setting time has elapsed from the synchronization timing after the exposure start timing;

an exposure controller that changes, when the amount of change is input, at least one of the start-setting time and the end-setting time on the basis of the amount of change; and

a synchronization managing apparatus that determines the shift amount according to a phase difference between the synchronization timing and a predetermined reference timing and inputs the shift amount into at least one of the first and second imaging apparatuses.

(5) An imaging apparatus, including:

a first imaging unit including
a synchronization signal generator that generates a first synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change;

a second imaging unit including
a synchronization signal generator that generates a second synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change; and

a synchronization manager that determines the amount of change according to a phase difference between the first and second synchronization signals and inputs the amount of change into at least one of the first and second imaging apparatuses.

(6) A control method for an imaging apparatus, including:

a synchronization signal generation step where a synchronization signal generator generates a synchronization signal indicating a synchronization timing for each of synchronization intervals;

a synchronization interval control step where a synchronization interval controller changes, when an amount of change of the synchronization interval is input, the synchronization interval according to the amount of change;

an imaging step where an imaging element generates image data by performing exposure within an exposure period between an exposure start timing when a start-setting time has elapsed from the synchronization timing and an exposure end timing when an end-setting time has elapsed from the synchronization timing after the exposure start timing; and

an exposure control step where an exposure controller changes, when the amount of change is input, at least one of the start-setting time and the end-setting time on the basis of the amount of change.

### DESCRIPTION OF SYMBOLS

100, 103 imaging apparatus
101 left-hand imaging apparatus
102 right-hand imaging apparatus
104 binocular imaging apparatus
105 left-hand imaging unit
106 right-hand imaging unit
110 image processor
120 video signal output unit
130 photodetector
140 vertical synchronization signal generator
150 vertical synchronization interval controller
160 exposure controller
170 external communication unit
200 imaging element
210 row scanning circuit
220 pixel array section
230 pixel circuit
231, 232, 236, 237 transfer transistor
233, 234, 235, 238 photoelectric conversion element
239 reset transistor
240 amplification transistor
241 select transistor
242 floating diffusion layer
250 horizontal synchronization timing-controlling circuit
260 AD converter
270 column scanning circuit
280 memory
290 output unit
300, 301 synchronization managing apparatus
302 synchronization manager
400, 401 image-analyzing apparatus
402 image analyzer
500 position detector
510 conveyor belt
520 product

1. An imaging apparatus, comprising:
a synchronization signal generator that generates a synchronization signal indicating a synchronization timing for each of synchronization intervals;
a synchronization interval controller that changes, when an amount of change of the synchronization interval is input, the synchronization interval according to the amount of change;
an imaging element that generates image data by performing exposure within an exposure period between an exposure start timing when a start-setting time has elapsed from the synchronization timing and an exposure end timing when an end-setting time has elapsed from the synchronization timing after the exposure start timing; and
an exposure controller that changes, when the amount of change is input, at least one of the start-setting time and the end-setting time on the basis of the amount of change.

2. The imaging apparatus according to claim 1, further comprising a photometry unit that measures an amount of light, wherein
the exposure controller controls, when the amount of light is measured, at least one of the start-setting time and the end-setting time on the basis of the amount of light.

3. An imaging system, comprising:
a first imaging apparatus including
a synchronization signal generator that generates a first synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change;
a second imaging apparatus including
a synchronization signal generator that generates a second synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change; and
a synchronization managing apparatus that determines the amount of change according to a phase difference between the first and second synchronization signals and inputs the amount of change into at least one of the first and second imaging apparatuses.

4. An imaging system, comprising:
a synchronization signal generator that generates a synchronization signal indicating a synchronization timing for each of synchronization intervals;
a synchronization interval controller that changes, when an amount of change of the synchronization interval is input, the synchronization interval according to the amount of change;
an imaging element that generates image data by performing exposure within an exposure period between an exposure start timing when a start-setting time has elapsed from the synchronization timing and an exposure end timing when an end-setting time has elapsed from the synchronization timing after the exposure start timing;
an exposure controller that changes, when the amount of change is input, at least one of the start-setting time and the end-setting time on the basis of the amount of change; and
a synchronization managing apparatus that determines the shift amount according to a phase difference between the synchronization timing and a predetermined reference timing and inputs the shift amount into at least one of the first and second imaging apparatuses.

5. An imaging apparatus, comprising:
a first imaging unit including
a synchronization signal generator that generates a first synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change;
a second imaging unit including
a synchronization signal generator that generates a second synchronization signal indicating a synchronization timing for each of synchronization intervals,
a synchronization interval controller that changes, when an amount of change of the synchronization interval is input, the synchronization interval according to the amount of change,
an imaging element that generates image data by performing exposure within an exposure period between an exposure start timing when a start-setting time has elapsed from the synchronization timing and an exposure end timing when an end-setting time has elapsed from the synchronization timing after the exposure start timing, and
an exposure controller that changes, when the amount of change is input, at least one of the start-setting time and the end-setting time on the basis of the amount of change; and
a synchronization manager that determines the amount of change according to a phase difference between the first and second synchronization signals and inputs the amount of change into at least one of the first and second imaging apparatuses.

6. A control method for an imaging apparatus, comprising:
a synchronization signal generation step where a synchronization signal generator generates a synchronization signal indicating a synchronization timing for each of synchronization intervals;
a synchronization interval control step where a synchronization interval controller changes, when an amount of change of the synchronization interval is input, the synchronization interval according to the amount of change;
an imaging step where an imaging element generates image data by performing exposure within an exposure period between an exposure start timing when a start-setting time has elapsed from the synchronization timing and an exposure end timing when an end-setting time has elapsed from the synchronization timing after the exposure start timing; and
an exposure control step where an exposure controller changes, when the amount of change is input, at least one of the start-setting time and the end-setting time on the basis of the amount of change.
